(19) United States
(12) Patent Application Publication
(10) Pub. No.: US 2025/0094648 A1
(43) Pub. Date: Mar. 20, 2025

(54) MEMORY SYSTEM AND METHOD FOR VERIFYING SAFETY

(71) Applicant: Kioxia Corporation, Tokyo (JP)

(72) Inventor: Narufumi KOYA, Kawasaki Kanagawa (JP)

(73) Assignee: Kioxia Corporation, Tokyo (JP)

(21) Appl. No.: 18/791,691

(22) Filed: Aug. 1, 2024

(30) Foreign Application Priority Data
Sep. 14, 2023 (JP) 2023-149091

(51) Int. Cl. G06F 21/79; G06F 21/64

(52) U.S. Cl. CPC G06F 21/79; G06F 21/64

(57) ABSTRACT

According to one embodiment, a memory system includes a nonvolatile memory and a controller. The controller verifies safety of a request source requesting to write data to or read data from the nonvolatile memory using a challenge-response type attestation.

### CROSS-REFERENCE TO RELATED APPLICATIONS

This application is based upon and claims the benefit of priority from Japanese Patent Application No. 2023-149091, filed Sep. 14, 2023, the entire contents of which are incorporated herein by reference.

### FIELD

Embodiments described herein relate generally to a memory system and a method for verifying safety.

### BACKGROUND

In recent years, with the spread of smartphones and cloud services, and the increasing use of internet of things (IoT) devices, an environment has been created in which various information devices and electronic devices are connected to the Internet. This environment has enabled a society in which remote information and devices can be accessed anytime, anywhere. In the past, most information apparatuses and electronic devices were managed by administrators with expertise, but now most information apparatuses and electronic devices are managed by administrators without expertise.

Devices connected to the Internet are exposed to various threats, such as the risk of malware intrusion affecting security and the risk of becoming a perpetrator of attack as the source of a distributed denial of service (DDOS) attack.

With this growing interest in security measures for information devices, security requirements for memory systems such as solid state drives (SSDs) are increasing day by day in order to safely protect various types of information when they are used.

Due to such background, for active devices, especially those connected to the Internet, mechanisms have been proposed to enhance safety of devices for each individual device.

In addition, as mechanisms for enhancing safety, a root of trust (ROT) for strictly managing information and a trusted execution environment (TEE), which is an isolated environment with the ability to safely execute specific processes independent of the operating system are becoming widely used.

Recently, with the introduction of these mechanisms for enhancing safety of devices into devices, it has become easier to establish a mechanism to prove the safety of device-specific devices.

On the other hand, a mechanism for proving mutual integrity by attestation is also currently being introduced as a mechanism for enhancing the safety of devices that are interoperable between devices that are operationally capable of communicating with each other. The mechanism for enhancing the safety of devices by attestation makes it possible to verify whether or not software running on devices that may have been compromised by malware, etc., has been compromised.

However, for passive devices used inside computers, including memory systems, although mechanisms for proving the safety of device-specific devices are introduced, there are limitations on the means of voluntary communication. Therefore, no mechanism has been introduced to enhance the safety of devices by attestation, in which the memory system verifies the software running on the device that uses the memory system.

In addition, NVM Express™ (NVMe™), an interface protocol that enables a host to access data stored in the memory system, is sometimes adopted between the host and the memory system. A memory system that employs NVM Express™ (NVMe™) cannot have the device initialized or its status monitored by configuration transactions from any device other than the host. Therefore, it is difficult for the memory system to perform mutual verification based on the communication used for attestation.

### BRIEF DESCRIPTION OF THE DRAWINGS

FIG. 1 is a diagram showing an example of a configuration of a computer system of a first embodiment.

FIG. 2 is a diagram showing an example of a configuration of a memory system of the first embodiment.

FIG. 3 is a diagram showing an example of a challenge-response type attestation.

FIG. 4 is a diagram showing an example of a criterion for determining permission/rejection of a read or write request in the memory system of the first embodiment.

FIG. 5 is a processing flow diagram for determining permission/rejection of the read or write request in the memory system of the first embodiment.

FIG. 6 is a sequence diagram in a case where a service/application reads/writes data with respect to the memory system in the computer system of the first embodiment.

FIG. 7 is a diagram showing an example of a configuration of a computer system of a second embodiment.

FIG. 8 is a diagram showing an example of another configuration of a criterion for determining permission/rejection of a read or write request in a memory system of a third embodiment.

### DETAILED DESCRIPTION

In general, according to one embodiment, a memory system includes a nonvolatile memory and a controller. The controller verifies safety of a request source requesting to write data to or read data from the nonvolatile memory using a challenge-response type attestation.

Embodiments will be described hereinafter with reference to the accompanying drawings.

### First Embodiment

First, a first embodiment is described.

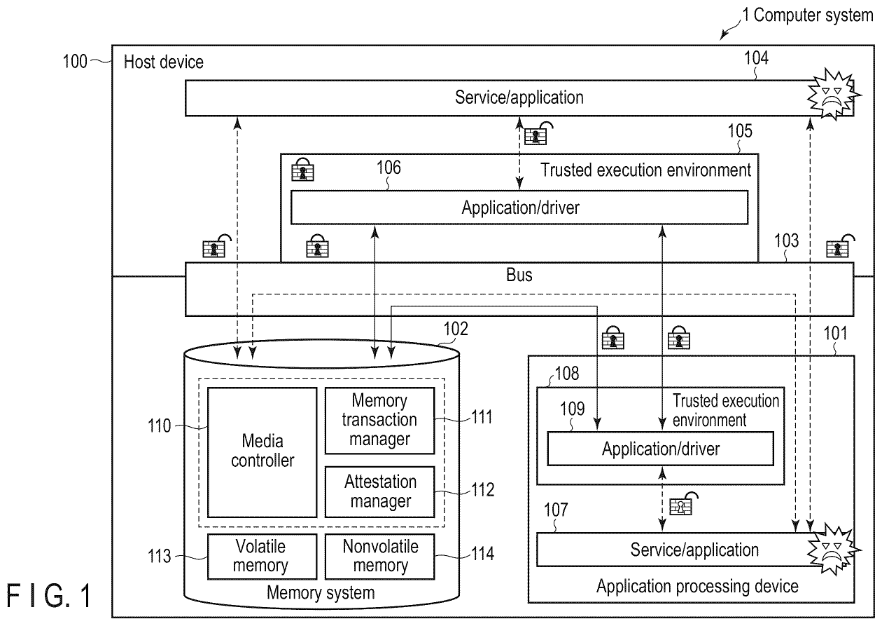

FIG. 1 is a diagram showing an example of a configuration of a computer system 1 of the first embodiment.

The computer system 1 includes a host device 100, an application processing device 101, and a memory system 102. The host device 100, the application processing device 101, and the memory system 102 are connected via a bus 103.

The host device 100 and the application processing device 101 are devices including a trusted execution environments (TEE) 105 and 108, which are isolated from root of trust (ROT), respectively. The host device 100 and the application processing device 101 include application/drivers 106 and 109 that perform verification-related processing with the memory system 102 in the trusted execution environments 105 and 108.

The host device 100 is, for example, a server or a personal computer (PC). The application processing device 101 is, for example, a graphics processing unit (GPU). In the host device 100, a service/application 104 that executes various information processing involving reading/writing data to/from the memory system 102 is operated. In the application processing device 101, a service/application 107 that executes various information processing involving reading/writing data to/from the memory system 102 is operated.

The memory system 102 includes a media controller 110, a memory transaction manager 111, an attestation manager 112, a volatile memory 113, and a nonvolatile memory 114. As shown in a dashed line, the media controller 110, the memory transaction manager 111, and the attestation manager 112 are configured in a circuit (device) such as a system on chip (SoC) as a controller. Some processes of the media controller 110, the memory transaction manager 111, and the attestation manager 112 can be realized by a CPU, included in the controller, executing a specific program.

For a secure path for the memory system 102 to perform verification, a path that is accessible by memory transaction is used. In the first embodiment, the memory system 102 is, for example, an NVMe™ SSD that communicates using a protocol compliant with the NVM Express™ (NVMe™) standard. The bus 103 is compliant with the PCI Express™ (PCIe™) standard.

The PCIe™ standard provides memory transactions for read/write operations on a memory address space, configuration transactions for device initialization, status monitoring, etc., I/O transactions for read/write operations on an I/O address space, and message transactions for event notification, etc. In the NVMe™ standard, configuration transactions, memory transactions, and I/O transactions are available as standard, and memory transactions with a controller memory buffer (CMB)/persistent memory region (PMR) function are available as an option. Therefore, in the first embodiment, the secure path is realized by memory transactions on an interface using the CMB/PMR function.

The CMB/PMR function is a function that exposes an internal memory area of the memory system 102 to applications via memory mapping (memory mapped I/O (MMIO)). The host device 100 or the application processing device 101 establishes a secure path with the memory system 102 via MMIO using the CMB/PMR function during a secure startup phase using the trusted execution environments 105 and 108. During normal read/write requests to the memory system 102, I/O transactions are used, which need not be a secure path. In FIG. 1, memory transactions with secure paths are represented by solid arrows, and other transactions are represented by dashed arrows.

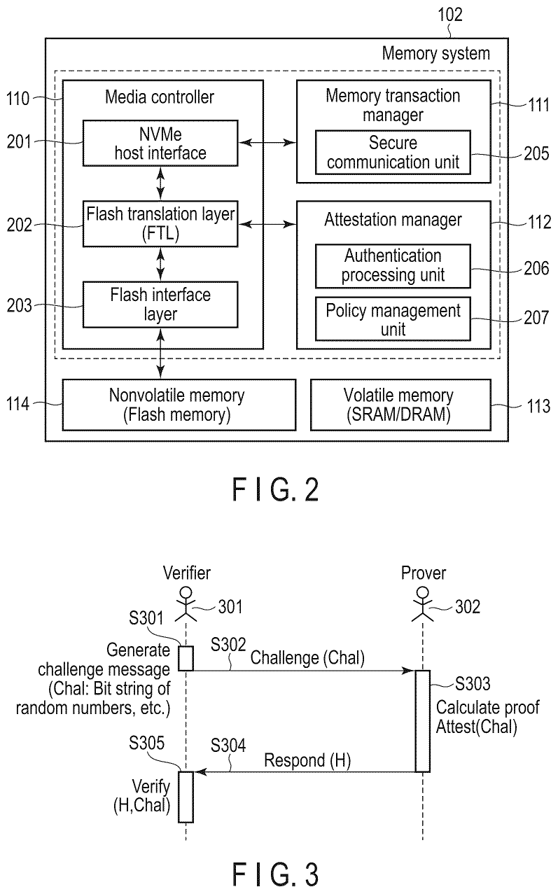

FIG. 2 is a diagram showing an example of a configuration of the memory system 102 of the first embodiment. In FIG. 2, a plurality of configurations within the dashed lines are configurations that function as a part of a controller.

The media controller 110 integrally controls the operation of the memory system 102. The media controller 110 includes an NVMe host interface 201, a flash translation layer (FTL) 202, and a flash interface layer 203. The NVMe host interface 201 is compliant with the NVMe standard and controls communication with the host device 100. The flash translation layer 202 manages the correspondence between an address managed by the host device 100 and a storage area of the memory system 102. The flash interface layer 203 controls communication with the nonvolatile memory 114.

The memory transaction manager 111 includes a secure communication unit 205. The secure communication unit 205 performs interface processing to establish a secure path by MMIO using the CMB/PMR function.

The attestation manager 112 performs a challenge-response type attestation. The attestation manager 112 includes an authentication processing unit 206 and a policy management unit 207. The authentication processing unit 206 manages and controls processing required for verification. The policy management unit 207 determines whether or not to perform verification.

The volatile memory 113 is, for example, static RAM [random access memory] (SRAM) or dynamic RAM (DRAM). The nonvolatile memory 114 is, for example, NAND flash memory.

FIG. 3 is a diagram showing an example of a challenge-response type attestation.

In the challenge-response type attestation, a challenge message containing a nonce and a key identifier is provided by a verifier 301 to a prover 302 (S301, S302). In (S301), the verifier 301 generates a challenge message. The challenge message is, for example, a bit string using random numbers.

The prover 302 responds by adding a signature to the nonce and a claim (prover property, etc.) using a private key corresponding to the key identifier (S303, S304).

The verifier 301 verifies the signature with a public key (S305).

In the challenge-response type attestation in the first embodiment, the MMIO using the CMB/PMR function realizes communication at the interface by a secure path. Therefore, in the first embodiment, at the phase of the secure path having been established, an MMIO in which the verifier 301 writes data to the internal memory of the prover 302, and the prover 302 reads data written by the verifier 301 from the internal memory, and an MMIO in which the prover 302 writes data to the internal memory, and the verifier 301 reads data written by the prover 302 from the internal memory of the prover 302 are prepared on the interface realized by the CMB/PMR function.

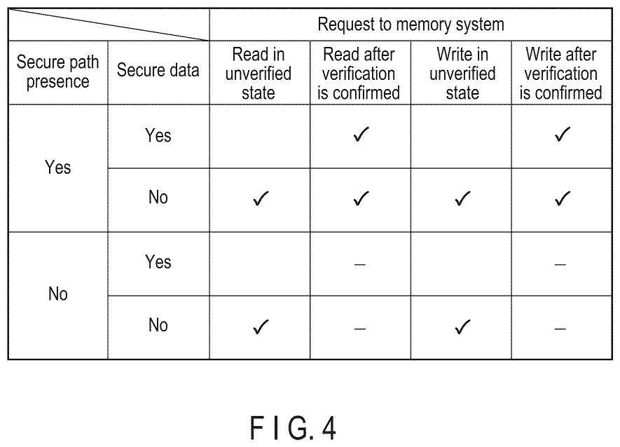

FIG. 4 is a diagram showing an example of a criterion for determining permission/rejection a read or a write request when the request is generated with respect to the memory system 102 in the policy management unit 207 of the attestation manager 112.

In the first embodiment, in the memory system 102 that provides safety verification of a request source, a secure path is essential for verification. Therefore, the memory system 102 does not perform verification in a case where the secure path has not been established (secure path presence: no). As a result, in the case where the secure path has not been established (unverified state), only control requests for data that does not require protection (secure data: no) are permitted.

In a case where a secure path has been established (secure path presence: yes), control requests for data that does not require protection (secure data: no) are permitted regardless of whether or not verification is performed. On the other hand, control requests for data that requires protection (secure data: yes) are not permitted until after verification is completed.

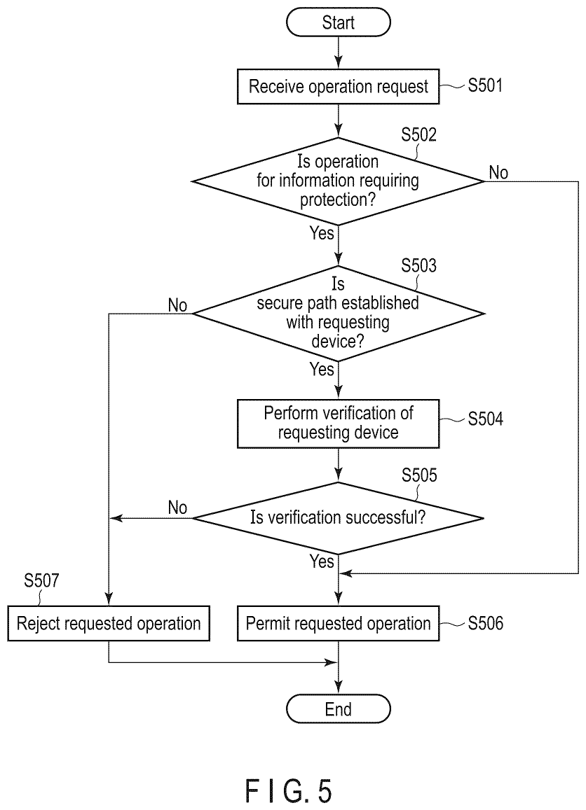

FIG. 5 is a diagram showing an example of a processing flow for determining permission/rejection of a read or write request by the policy management unit 207 of the attestation manager 112 when the request with respect to the memory system 102 is generated.

When the memory system 102 receives an operation request (S501), it determines whether or not the operation is for information that requires protection (S502). In a case where the operation is not for information that requires protection (S502: No), the memory system 102 permits the requested operation (S506).

In a case where the operation is for information that requires protection (S502: Yes), the memory system 102 then determines whether or not a secure path is established with a requesting device (S503). In a case where the secure path has not been established (S503: No), the memory system 102 rejects the requested operation (S507).

In a case where the secure path is established (S503: Yes), the memory system 102 performs verification of the requesting device (S504). The memory system 102 determines whether the verification is successful or not (S505). In a case where the verification is successful (S505: Yes), the memory system 102 permits the requested operation (S506). On the other hand, in a case where the verification fails (S505: No), the memory system 102 rejects the requested operation (S507).

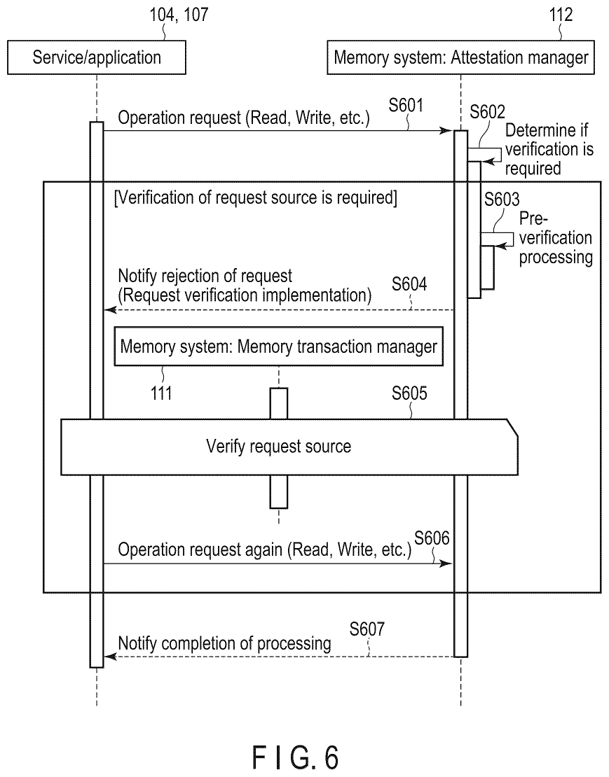

FIG. 6 is a diagram showing an example of a sequence in a case where data read/write is performed by the services/applications 104 and 107 with respect to the memory system 102 in the computer system 1 according to the first embodiment.

When the services/applications 104 and 107 generate an operation request by an I/O transaction (S601), the attestation manager 112 of the memory system 102 determines whether or not a target of the operation request requires verification of a request source (S602). The operation request includes, for example, a request to read or write data with respect to the memory system 102.

Based on the determination of the verification of the request source being required, the attestation manager 112 prepares a challenge message in a challenge-response type attestation with a memory transaction as pre-verification processing (S603). The attestation manager 112 notifies the rejection of the operation request by the previous I/O transaction with an error code indicating that verification is required (S604).

The services/applications 104 and 107 and the memory transaction manager 111 of the memory system 102 complete the verification using the challenge-response type attestation by the memory transaction shown in FIG. 3 on the secure path shown in FIG. 1 (S605). After the verification, services/applications 104 and 107 again make an operation request by the I/O transaction (S606). The memory system 102 completes the operation on the target of the operation request and notifies the services/applications 104 and 107 of the completion of the processing (S607).

As described above, in the computer system 1 of the first embodiment, the safety of the service/application 104 of the host device 100 or the service/application 107 of the application processing device 101 that makes a request to the memory system 102 can be actively verified by the memory system 102 with the challenge-response type attestation.

More specifically, the computer system 1 of the first embodiment enables the memory system 102 which is a passive device, to perform a challenge-response type attestation which requires active operation, by using an interface corresponding to a memory transaction as a secure path.

Then, in the memory system 102, by verifying the request source and determining whether or not the operation request is acceptable, the computer system 1 of the first embodiment improves the problems of eavesdropping and unauthorized use of information that poses a serious threat of information leakage when it is moved outside the memory system 102.

### Second Embodiment

Next, a second embodiment is described.

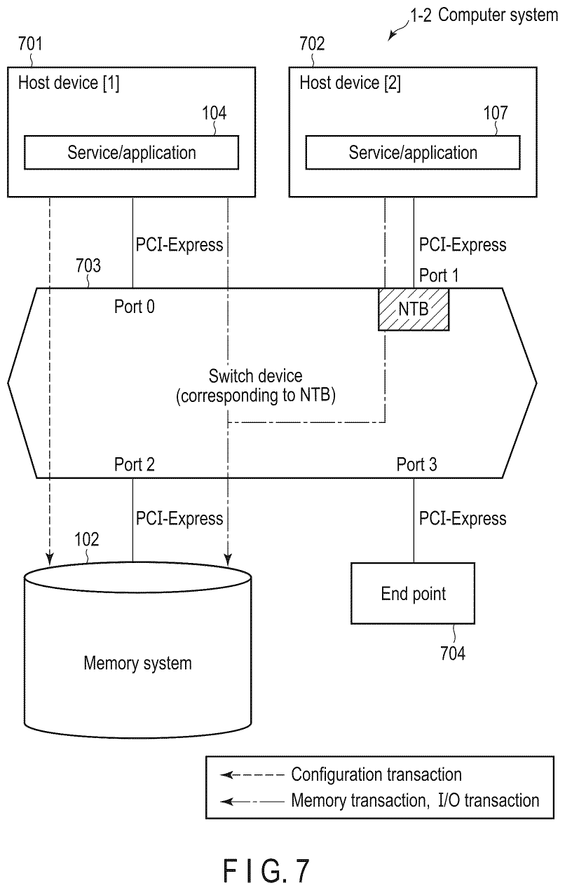

FIG. 7 is a diagram showing an example of a configuration of a computer system 1-2 of the second embodiment.

In the second embodiment, an example is shown in which a memory system 102 is an NVMe™ SSD, and a bus to which the memory system 102 and host devices 701 and 702 in a multi-host configuration are connected is a PCIe™ bus.

In the PCIe™ standard, each device is connected on a one-to-one (peer-to-peer) basis. Therefore, a switch device is necessary to increase the number of connected devices. In the multi-host configuration, the connection between each of the plurality of host devices 701 and 702 and the memory system 102 is realized by using a switch device 703 with a non transparent bridge (NTB) function. In the case of the PCIe™ standard, both configuration transactions and message transactions which are transactions to access each device, cannot pass through the NTB in the multi-host configuration. Therefore, the host device 702 cannot initialize or monitor the status with respect to the memory system 102.

The computer system 1-2 of the second embodiment employs memory transactions as transactions for verification where active control is expected. This makes it possible to perform verification for a plurality of host devices without being subject to the restrictions of a multi-host configuration.

In the computer system 1-2 of the second embodiment, the secure path realizes communication with an interface by MMIO. This makes it possible to use the secure path for status monitoring requests from the host device 702 to the memory system 102 that passes through the NTB.

### Third Embodiment

Next, a third embodiment is described.

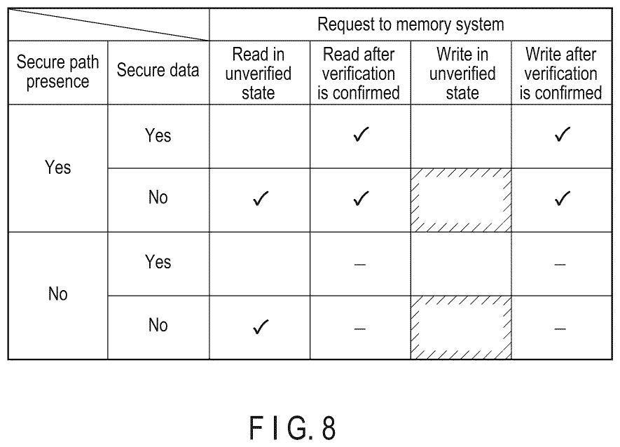

FIG. 8 is a diagram showing another example of criterion for determining permission/rejection a read or a write request when the request to a memory system 102 is generated in a policy management unit 207 of an attestation manager 112 in the third embodiment.

As shown in FIG. 8, in the policy management unit 207 of the attestation manager 112, the criterion for permitting/rejecting a request when a read or write request to the memory system 102 is generated may be that, if a request source is unverified, writing is prohibited even for a control request for data that does not require protection.

By implementing an operation in which writing is not permitted without verification of the request source, the threat of unauthorized acquisition of information using buffer overflow, which is assumed to occur due to information leakage due to unauthorized operation in the memory system 102, can be reduced. More specifically, since the unauthorized acquisition of information using buffer overflow starts from a write request to the memory system 102, the threat can be reduced even in a case where there are implementation problems related to writing to the memory system 102.

### Fourth Embodiment

Next, a fourth embodiment is described.

The request source verification shown in FIG. 6, described in the first embodiment, may be executed periodically instead of starting with an I/O transaction. In this case, a host device 100 needs to constantly monitor an interface for verification established on a secure path and perform verification with a challenge-response type attestation when it detects a verification request from a memory system 102. On the other hand, an attestation manager 112 of the memory system 102 does not need to notify that the request was rejected due to verification failure as a response to the request from the I/O transaction by services/applications 104 and 107.

In the fourth embodiment, for the services/applications 104 and 107 running on the host device 100, there is no need to be aware of the verification from the memory system 102. According to the fourth embodiment, it is possible to inadvertently verify whether or not software has been compromised, independently of operation requests from the services/applications 104 and 107, etc.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory; and
a controller configured to verify safety of a request source requesting to write data to or read data from the nonvolatile memory using a challenge-response type attestation.

2. The memory system of claim 1, wherein the controller is further configured to verify the safety of the request source based on a standard I/O transaction from the request source.

3. The memory system of claim 1, wherein the controller is further configured to determine whether or not to reject a request from the request source based on at least one of the following: i) whether or not a target of the request from the request source is data that requires protection, ii) whether or not a secure path has been established with the request source, and iii) whether or not safety of the request source is verified.

4. The memory system of claim 3, wherein, in a case where it is determined that the request from the request source should be rejected, the controller is further configured to notify the request source of the rejection of the request.

5. The memory system of claim 1, wherein the controller is further configured to:
communicate with the request source using a protocol compliant with an NVM Express™ (NVMe™) standard; and
establish a secure path with the request source by a memory mapped I/O (MMIO) using a controller memory buffer (CMB)/persistent memory region (PMR) function supported by the NVMe™ standard.

6. The memory system of claim 1, wherein, in a case where the safety of the request source is not verified, the controller is further configured to determine to reject the request from the request source even if a target of the request from the request source is data that does not require protection.

7. The memory system of claim 1, wherein the controller is configured to periodically verify safety of the request source.

8. The memory system of claim 1, wherein the nonvolatile memory includes a NAND type flash memory.

9. A method for verifying safety of a request source configured to request processing to a memory system having a nonvolatile memory, the method comprising
verifying the safety of the request source requesting to write data to or read data from the nonvolatile memory using a challenge-response type attestation.

10. The method of claim 9, further comprising verifying the safety of the request source based on a standard I/O transaction from the request source.

11. The method of claim 9, further comprising determining whether or not to reject a request from the request source based on at least one of the following: i) whether or not a target of the request from the request source is data that requires protection, ii) whether or not a secure path has been established with the request source, and iii) whether or not safety of the request source is verified.

12. The method of claim 11, further comprising, in a case where it is determined that the request from the request source should be rejected, notifying the request source of the rejection of the request.

13. The method of claim 9, further comprising:
communicating with the request source using a protocol compliant with an NVM Express™ (NVMe™) standard; and
establishing a secure path with the request source by a memory mapped I/O (MMIO) using a controller memory buffer (CMB)/persistent memory region (PMR) function supported by the NVMe™ standard.

14. The method of claim 9, further comprising, in a case where the safety of the request source is not verified, determining to reject the request from the request source even if a target of the request from the request source is data that does not require protection.

15. The method of claim 9, further comprising periodically verifying safety of the request source.

16. The method of claim 9, wherein the nonvolatile memory includes a NAND type flash memory.
